(19) United States
(12) Patent Application Publication
(10) Pub. No.: US 2005/0263566 A1
(43) Pub. Date: Dec. 1, 2005

(54) Substrate holding apparatus

(75) Inventor: Guanghui Su, Singapore (SG)

Correspondence Address: GUANGHUI SU, 303C ANCHORVALE LINK #10-124, SINGAPORE, 543303, SG

(73) Assignee: guanghui su, Singapore (SG)

(21) Appl. No.: 10/908,779

(22) Filed: May 26, 2005

Related U.S. Application Data
(60) Provisional application No. 60/521,580, filed on May 27, 2004.

(51) Int. Cl. B23K 37/00; B23K 31/00

(52) U.S. Cl. 228/44.3; 228/180.5; 228/4.5

(57) ABSTRACT

A substrate holding apparatus for semiconductor processing like wire bonding process is disclosed. Two or more holding points at both side of center locating point are provided to created a distributed holding force at clamp tool holding shoulder to generate a moment about substrate moving direction to act on clamp tool so that clamp tool can clamp on substrate more evenly at all sides for better process quality.

### BACKGROUND OF INVENTION

During semiconductor wire bonding process, substrates like leadframe or stripe with die attached are hold between support block and clamp tool with window opening to expose die and welding points on substrate for processing. The function of substrate holding apparatus is to hold substrate steady against support block so that wire can be welded to die and leads in good quality. Due to high dynamic of wire bonding process and shape defects of substrate, sometime poor quality welding happened because of clamping not effective.

Most substrate clamp tool link at two side shoulders in the middle of its width to wire bond machine. This is because substrate will be processed while traveling in a guide rail by a transport mechanism in front of rail and wire welding mechanism are located at the other side of rail. That leaves the two sides across the moving direction as holding points. Clamp tool link to wire bond machine through a unit called clamp holder, which normally consists of clamp holder and some force mechanism. The holding of clamp tool by clamp holder besides provide clamp force and location for clamp tool, it also need to accommodate the need for quick and easy change over of clamp tool. One way to do this is through a ball or pin driven by some spring mechanism on clamp holder to mate with a hole or slot in clamp tool to locate and hold clamp tool for quick change over. Ball or pin diameter is bigger than hole or slots on clamp tool and hold clamp tool by ball or pin seating on top edge of hole or slot.

Clamp holder, holding clamp tool, which positioned on top of substrate, is driven by a linear drive unit to move up and down. A support block is normally placed underneath substrate and driven by another linear drive unit to move up and down also. Substrate is hold at a designed position by clamping in between clamp tool and support block through programmed move sequence. One design of clamp force mechanism is clamp tool, besides move up and down with clamp holder, also have a small relative moving stroke with clamp holder within hard stops on clamp holder and pressed against lower stop by spring loaded ball.

Clamp tool with window opening in center and hold at two side shoulders are a conventional clamp tool design used by most wire bond machines.

There are open position and close position for substrate holding apparatus. At open position, clamp tool, substrate and support block are apart from each other and substrate can move freely. At close position, substrate is clamped by clamp tool and support block and positioned at working/holding position. At this position, leadframe will be processed.

U.S. Pat. No. 5,307,978 of Rickertson et al. discloses a leadframe clamping apparatus having an upper clamp plate hold to clamp holder in centerline at two sides.

U.S. Pat. No. 5,035,034 of Cotney disclose a leadframe clamp design, which have spring fingers attached to clamp tool to hold on leadframe. This clamp tool link to wire bond machine through hole on clamp tool at two sides with pins on clamp holder in wire bond machine.

To improve quality of bonding, mechanisms have better clamp effect on substrate were exploited. Some special clamp tool designs were disclosed and within them;

U.S. Pat. No. 6,634,538 of Evers, et al. disclose a leadframe clamp tool design with a membrane attached to clamp tool and the membrane will clamp on leadframe. This design uses the flexibility of membrane to compensate leadframe unevenness to have better clamp effect on leadframe.

U.S. Pat. No. 6,651,868 of Kawamura disclose a leadframe clamp tool design with slits around clamp window to produce some flexibility around window opening to compensate substrate unevenness.

These designs go in the direction to modify clamp tool to add in some flexibility to accommodate substrate deformation. But look at the system, clamp tool link to wire bond machine through clamp holder by hold/locate ball or pin in two shoulder of clamp. These hold/locating points will pass clamping force generated from mechanism in wire bond machine or clamp holder down to clamp point in clamp tool to hold on substrate. In view of moment in clamp surface plane, the moment about axis perpendicular to substrate moving direction is much bigger than moment along moving direction because the one-ball linkage design. As clamp window is normally a square shape cut out in the center of clamp tool and contact area are a narrow shoulder around window, moment to hold down substrate in two along substrate moving direction side is much smaller than moment hold down the other two side. This huge difference in moment will cause clamp to have a big difference in hold down force around window opening. This is a main shortage of existing clamping mechanism in hold down substrate and a source for process instability. Even though flexibility is build into clamp tool with the new inventions, which help to compensate some degree of unevenness on substrate, but because clamp tool is hold too much weak in one direction than other by its driving mechanism, poor clamping also happens.

### SUMMARY OF INVENTION

The primary object of this invention is to provide an apparatus design with improved connection between clamp tool and clamp holder to have better clamp effect on substrate. In this invention, multiple holding points are provided besides traditional single locating/holding point at clamp tool connection to clamp holder to produce a much bigger holding moment in about substrate moving direction to improve currently used clamp holding method which only have a strong moment in perpendicular to substrate moving direction.

It is further the objective of this invention that the added on holding points will provide moment acting on clamp tool while clamping on device but does not affect the locating function of center holding point currently using while clamp tool in opening position or during clamp tool change over.

To fulfill the objectives of this invention, a set of holding points are provided besides center-locating ball at both sides. These holding points will have spring-loaded balls face a flat surface on clamp tool side shoulder top at both sides of center/holding ball. These balls are guided in holes with lower limit to set ball lower position and pressed on top by flat springs. At open position, these holding balls will not touch clamp tool. At clamp closing position, these holding balls will press on clamp tool. These holding points and locating point form an integral part of a substrate holding apparatus.

### BRIEF DESCRIPTION OF DRAWINGS

FIG. 1 Substrate holding apparatus

FIG. 2 Exploded view of substrate holding apparatus

FIG. 3 Clamp tool linkage to clamp holder at open position

FIG. 4 Clamp tool linkage to clamp holder at close position

### DETAILED DESCRIPTION

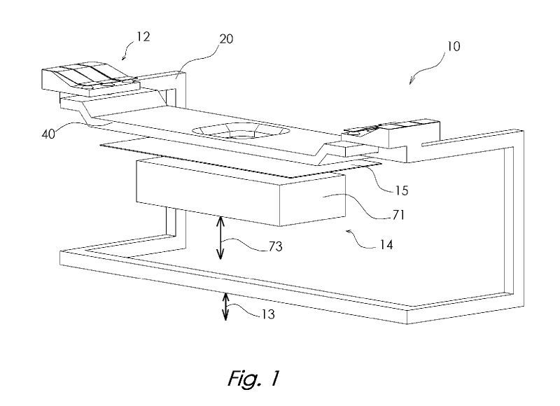

As shown in FIG. 1. Substrate holding apparatus 10, consists of clamp holder unit 12 and support unit 14, clamp substrate 15 with certain holding force at desired height for processing. Clamp holder unit 12 have clamp holder 20 link with clamp tool 40 through linkage mechanism, which will be the center of this invention and stated in detail by following description. A linear drive unit 13, detail not shown here, drive clamp holder 20 move up and down in vertical direction. Clamp tool 40 is placed above substrate 15 while support unit 14 is placed underneath substrate 15. Support unit 14 consists of support block 71 and linear drive unit 73, detail not shown here, to move up and down in vertical direction.

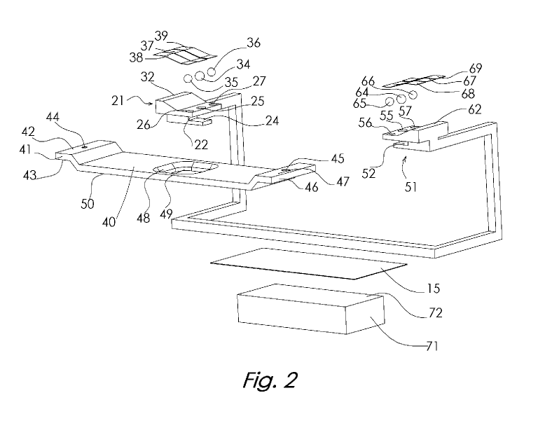

FIG. 2 is an exploded view of substrate holding apparatus 10. Clamp tool 40 further consists of left hold shoulder 41 and right hold shoulder 46, hole 44 and slot 45 on shoulder 41 and 46, window 48 at the center of clamp and clamp shoulder 49 around window 48 in facing substrate side, which is a narrow shoulder further protrude below clamp bottom surface 50. Surface 42 and 43 are top and bottom surface of shoulder 41.

Clamp holder 20 further consists of left holder 21 and right holder 51 with symmetrical design. On left holder 21, there is an opening 22 with top limit 23 and bottom limit 24. Hole 25 is located at center on top portion of opening 22 and hole 26 and 27 on both side of hole 25.

Ball 34 is placed in and guided by hole 25 and can move up and down while pressed on top by spring 37 which mount to surface 32 of clamp holder 20 with means not shown here. A shoulder 28 at bottom of hole 25 serve as lower limit for ball 34. Similar arrangement are made for ball 35 and 36 by placed in and guided by holes 26 and 27 with shoulder 29 and 30 and pressed on top by spring 38 and 39 respectively and able to move in vertical direction.

Right holder 51 of clamp holder 20 is a symmetrical design with left holder 21. There is an opening 52 and ball 64˜66 pressed by spring 67˜69, which mount to surface 62 with means not shown here, in hole 55˜57.

The substrate holding apparatus is a symmetric design except locating hole on clamp tool normally is one side round hole and the other side a slot with similar function (slot is used for dimensional compensation). Following description will be centered on the clamp apparatus side with hole on clamp tool and same design apply to slot side.

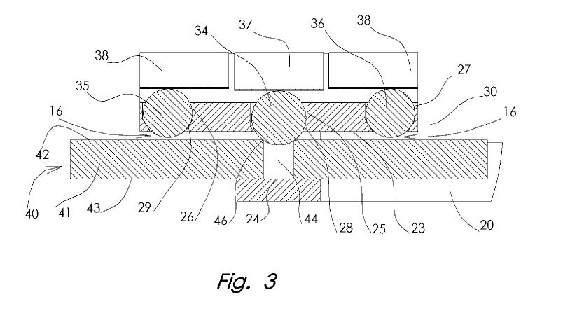

FIG. 3 shows clamp tool linkage to clamp holder at open position. Clamp tool 40 shoulder 41 will go into clamp holder 20 left open 22 and seating on bottom limit 24 under force from ball 34, which further pressed by Spring 37. Ball 34 seating on edge 46 of hole 44 on clamp tool 40. Ball 35 and 36 pressed by spring 38 and 39, seating on shoulder 29 and 30 of hole 26 and 27 respectively. There is a gap 16 between ball 35/36 and clamp tool 40 shoulder 41 top surface 42. This design arrangement is to make sure the added new force points did not affect the locating function of center ball and easiness of clamp tool handling at open position.

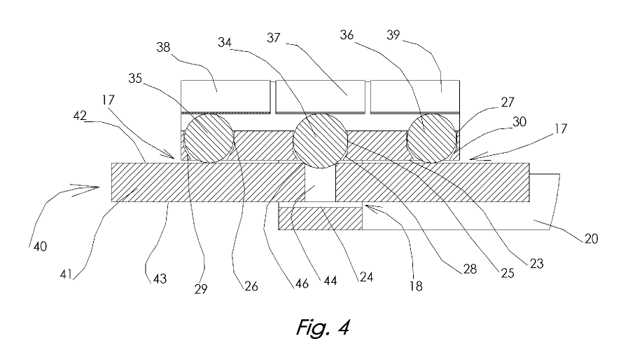

FIG. 4 shows a clamp tool linkage to clamp holder in close position. From open position as shown in FIG. 3, support block 71, driven by linear drive unit 73, move up and raise substrate 15 up to a desired height while clamp holder unit 12 holding clamp tool 40 and driven by linear drive unit 13 move downward. At close position, shoulder 49 of clamp tool 40 clamp on substrate 15 with top surface 72 of support block 71 and hold it for processing. Clamp tool 40, under pressure from combined travel by support block 71 and clamp holder 20, raise up its position as refer to clamp holder 20 so that its bottom surface 43 left clamp holder 20 bottom limit 24 and press ball 34 upward and then further compress spring 37. At close position, there is still a gap 17 between clamp tool 40 top surface 42 and clamp holder upper limit 23. Ball 35 and 36 also come into contact with clamp tool 40 top surface 42 and raised up from shoulder 29 and 30 in hole 26 and 27 with spring 38 and 39 being further compressed. Gap 18 exists between clamp tool 40 shoulder 41 bottom surface 43 and lower limit 24 on clamp holder 20. As a result, there are three forces from ball 34,35 and 36 pushing on top surface 42 of clamp tool 40 left shoulder 41. Similarly, on right shoulder 46 of clamp tool 40, three forces from ball 55, 56 and 57 will be pushing on shoulder 46 top surface 47. These forces will be balanced by the force acting on shoulder 49 around window 48.

The distributed forces along holding shoulder by three balls will generate a moment in about substrate moving direction to have a better holding on substrate 15 by shoulder 49 of clamp tool 40. This substrate holding apparatus, with the moment from distributed force, will strengthen the clamping on two along substrate moving direction side hold on substrate 15 to improve on the weak point of existing design so as to have a better holding effect and then more stable wire bonding process.

It will be understood that to those skilled in the art that various changes, additions, deletions, modifications may be added in the improved substrate holding apparatus as disclosed herein without departing from the spirit and scope of the invention as defined in the following claims. For example, more holding points can be added and spring can also be changed to other type.

1. A substrate holding apparatus comprise of clamp holder with multiple force points, clamp tool and support block.

2. The substrate holding apparatus as stated in claim 1 that its clamp holder have spring loaded balls as holding points at the sides of locating point which is also a spring loaded ball.

3. The substrate apparatus as stated in claim 1 that further have holding point balls positioned higher than center locating ball so that while center ball engage with locating hole on camp tool holding shoulder and at open position, there is no contact between holding balls and clamp tool shoulder top surface, which is flat underneath holding balls.

4. The substrate holding apparatus as stated in claim 1 that its holding balls will press on clamp tool shoulder top surface at close position to provide holding force together with center ball to push on clamp tool and create a moment about substrate moving direction to hold on clamp tool to further clamp on substrate together with support block.
